(19) United States
(12) Patent Application Publication
(10) Pub. No.: US 2012/0067444 A1
(43) Pub. Date: Mar. 22, 2012

(54) LEVELING VALVE

(75) Inventor: Toshiya Amikura, Kanagawa (JP)

(73) Assignee: KAYABA INDUSTRY CO., LTD., Tokyo (JP)

(21) Appl. No.: 13/322,310

(22) PCT Filed: Apr. 28, 2010
(86) PCT No.: PCT/JP2010/057922

§ 371 Date: Nov. 23, 2011

(30) Foreign Application Priority Data
Jun. 18, 2009 (JP) 2009-145354

(51) Int. Cl. B60G 17/052

(52) U.S. Cl. 137/627.5

(57) ABSTRACT

A contracted portion having an axial length is formed in the spool hole and a large diameter portion having an axial length is formed in the spool within the spool such that an annular gap is formed there-between. A valve body closes an opening portion of the spool hole. When the valve body is lifted, one of an air pressure source and a drain is connected to an air spring passage via the annular gap. When the spool retreats from the valve body, the other of the air pressure source and the drain is connected to the air spring passage via the annular gap. By setting the lengths at different values, different flow rate characteristics are realized when supplying compressed air to an air spring and discharging air from the air spring.

### RELATED APPLICATIONS

The present application is a National Phase of International Application Number PCT/JP2010/057922, filed Apr. 28, 2010 and claims priority from, Japanese Application Number 2009-145354, filed Jun. 18, 2009.

### FIELD OF THE INVENTION

This invention relates to a leveling valve that supplies compressed air to an air spring of a railway vehicle and discharges air from the air spring.

### BACKGROUND OF THE INVENTION

JP2004-52889A published in 2004, and JP2001-315516A published in 2001 respectively by the Japan Patent Office propose a leveling valve that keeps a support position in which an air spring of a railway vehicle supports the railway vehicle constant by supplying compressed air to the air spring or discharging air from the air spring.

The leveling valve raises a support position of a vehicle body by supplying compressed air to the air spring from a compressor when a load exerted on the vehicle body increases such that the vehicle body sinks relative to a bogie. When the load on the vehicle body decreases such that the vehicle body floats up from the bogie, the leveling valve lowers the support position of the vehicle body by draining the air in the air spring into the atmosphere.

The railway vehicle includes a lever that rotates in accordance with the support position of the vehicle body relative to the bogie. The leveling valve connects an air spring passage leading to the air spring selectively to the compressor and a drain in accordance with a rotation position of the lever.

According to JP2004-52889A, the leveling valve includes a hollow spool having an open tip end, an enlarged diameter portion formed on the tip end of the spool, a spool hole housing the spool, and a valve body that opposes the spool from an axial direction and closes the spool hole.

The spool is coupled to the lever so as to displace in the axial direction within the spool hole in accordance with the rotation position of the lever. The valve body is biased by a spring to be seated on an opening portion of the spool hole. The compressed air from the compressor is led to a periphery of the valve body. A hollow portion of the spool communicates with the drain. The drain is open to the atmosphere. A port of the air spring passage faces an outer periphery of the spool on an opposite side of the enlarged diameter portion to the valve body, and opens onto the spool hole.

When the lever is in a neutral position, the valve body is seated on a valve seat such that the tip end of the spool contacts the valve body. In this state, the air spring passage is shut off from both the compressor and the drain. The support position of the vehicle body when the lever is in the neutral position is referred to as a neutral position of the vehicle body.

When the vehicle body in the neutral position sinks relative to the bogie, the rotating lever drives the spool in a direction for lifting the valve body. When the valve body is lifted, the compressed air led to the periphery of the valve body from the compressor flows into the air spring passage through an annular gap formed by the spool hole and the enlarged diameter portion of the spool.

When the vehicle body sinks further relative to the bogie, the spool lifts the valve body further such that the enlarged diameter portion projects to the outside of the spool hole. Accordingly, the annular gap formed between the enlarged diameter portion and the spool hole disappears. As a result, a flow area of the compressed air flowing into the air spring passage increases rapidly such that a large amount of the compressed air is supplied to the air spring passage.

When the vehicle body floats up relative to the bogie from the neutral position, on the other hand, the lever drives the spool in a direction retreating from the valve body. As a result, the valve body holds the spool hole in a closed state, but the tip end of the spool and the valve body separate from each other, and therefore the hollow portion of the spool and the air spring passage facing the outer periphery of the spool are connected via the annular gap between the spool hole and the enlarged diameter portion. Accordingly, the air of the air spring is discharged into the atmosphere from the air spring passage via the annular gap and the hollow portion of the spool.

When the vehicle body floats up further relative to the bogie, the spool retreats greatly to the vicinity of the opening portion of the air spring passage, whereby the air of the air spring flows out of the air spring passage directly into the hollow portion of the spool without passing through the annular gap between the spool hole and the enlarged diameter portion. As a result, a flow area of a flow passage extending from the air spring passage to the hollow portion of the spool increases rapidly such that a large amount of air is discharged into the atmosphere through the air spring passage.

Hence, when the support position of the vehicle body relative to the bogie is near the neutral position, the leveling valve causes air to flow at a small flow rate based on a flow resistance of the annular gap both when supplying compressed air to the air spring and discharging air from the air spring, and as a result, the support position in which the air spring supports the vehicle body is corrected to the neutral position. When the support position of the vehicle body relative to the bogie deviates greatly from the neutral position, on the other hand, the leveling valve moves the air on the basis of a large flow area not restricted by the annular gap both when supplying air to the air spring and discharging air from the air spring. By moving a large amount of air, the support position in which the air spring supports the vehicle body is quickly corrected to the vicinity of the neutral position.

### SUMMARY OF THE INVENTION

A flow rate characteristic of the leveling valve described above is shown in FIG. 6. When the lever that drives the spool rotates to the vicinity of the neutral position, an air flow rate of the leveling valve is small both when supplying compressed air to the air spring and discharging air from the air spring due to the flow resistance generated by the annular gap. When the lever rotates beyond a fixed angle, the annular gap disappears, and therefore the leveling valve causes the air to flow at a large flow rate.

As is evident from FIG. 6, the leveling valve exhibits identical characteristics both when supplying compressed air to the air spring and discharging air from the air spring. In other words, a flow rate characteristic curve exhibits left-right symmetry about an ordinate in FIG. 6. However, to secure sufficient design freedom in the air spring and prevent hunting from occurring when air is supplied and discharged in the vicinity of the neutral position, it may be necessary to set different flow rate characteristics during supply of the compressed air to the air spring and discharge of the air from the air spring.

It is therefore an object of this invention to provide a leveling valve capable of modifying a flow rate characteristic when supplying compressed air to an air spring and discharging air from the air spring.

In order to achieve the above object, a leveling valve according to this invention, which selectively connects an air pressure source and a drain to an air spring, comprises a spool hole having a contracted portion in an opening portion thereof, a spool that displaces in an axial direction within the spool hole in accordance with a load exerted on the air spring, and an air spring passage that communicates with the air spring and faces an outer periphery of the spool. The spool has an enlarged diameter portion formed on an outer periphery thereof so as to face the contracted portion, and a hollow portion. The enlarged diameter portion is formed with a larger outer diameter than another part of the spool, and an annular gap is formed between the enlarged diameter portion and the contracted portion. An axial length of the enlarged diameter portion differs from an axial length of the contracted portion.

The leveling valve further comprises a valve body seated on the opening portion of the spool hole so as to face the spool, a spring that elastically supports the valve body in a seated position, a first passage that connects one of the air pressure source and the drain to the air spring passage via the annular gap when the valve body is pushed by the spool so as to be lifted from the opening portion of the spool hole, and a second passage that connects another of the air pressure source and the drain to the air spring passage via the annular gap and the hollow portion when the spool displaces in a retreating direction from the valve body.

The details as well as other features and advantages of this invention are set forth in the remainder of the specification and are shown in the accompanying drawings.

### BRIEF DESCRIPTION OF THE DRAWINGS

FIG. 1 is a longitudinal sectional view of a leveling valve according to this invention.

FIG. 2 is an enlarged side view of essential parts of the leveling valve for the purpose of illustrating an example relating to dimension setting of an enlarged diameter portion and a contracted portion of the leveling valve.

FIG. 3 is a diagram showing a flow rate characteristic of the leveling valve corresponding to the dimension setting of FIG. 2.

FIG. 4 is an enlarged side view of essential parts of the leveling valve for the purpose of illustrating another example relating to dimension setting of the enlarged diameter portion and the contracted portion of the leveling valve.

FIG. 5 is a diagram showing a flow rate characteristic of the leveling valve corresponding to the dimension setting of FIG. 4.

FIG. 6 is a diagram showing a flow rate characteristic of a leveling valve according to the prior art.

### DESCRIPTION OF THE PREFERRED EMBODIMENTS

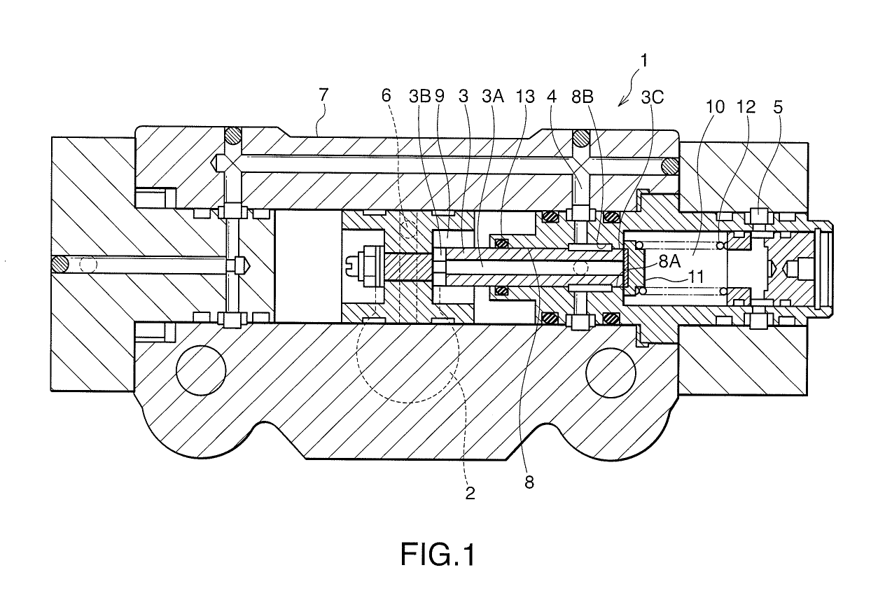

Referring to FIG. 1 of the drawings, a leveling valve 1 according to this invention is interposed between a bogie of a railway vehicle and a vehicle body supported on the bogie via an air spring, and serves to keep a support height of the vehicle body relative to the bogie constant.

The leveling valve 1 is mounted on the vehicle body and coupled to the bogie via a lever 2 and a link. A tip end of the lever 2 is coupled to a spool 3 of the leveling valve 1. When the support height at which the air spring supports the vehicle body varies due to variation in a load exerted on the vehicle body, this variation causes the lever 2 to rock via the link, and as a result, the spool 3 coupled to the tip end of the lever 2 is driven in an axial direction.

The leveling valve 1 connects a first passage 5 connected to a compressor serving as an air pressure source and a second passage 6 connected to a drain selectively to an air spring passage 4 connected to the air spring in accordance with a displacement of the spool 3. It should be noted that the drain is open to the atmosphere.

The leveling valve 1 includes a valve housing 7 fixed to the vehicle body. A spool hole 8 housing the spool 3 is formed in the valve housing 7. Two ends of the spool hole 8 open respectively onto spaces 9, 10 in the valve housing 7. A coupling portion coupling the spool 3 and the lever 2 is housed in the space 9. The second passage 6 is connected permanently to the space 9.

A valve body 11 is housed in the space 10. The valve body 11 is biased toward an opening portion of the spool hole 8 from an opposite side to the spool 3 by a spring 12 disposed in the space 10 so as to be seated on a valve seat formed in the opening portion, thereby shutting off the opening portion from the space 10. The first passage 5 is connected to the space 10.

The air spring passage 4 faces an outer periphery of the spool 3 and opens onto an inner side of the spool hole 8. A hollow portion 3A is formed in the spool 3. The hollow portion 3A opens onto an end surface of the spool 3 facing the valve body 11. Further, the hollow portion 3A communicates with the space 9 at all times via a drain port 3B formed in a radial direction in an opposite side end portion of the spool 3.

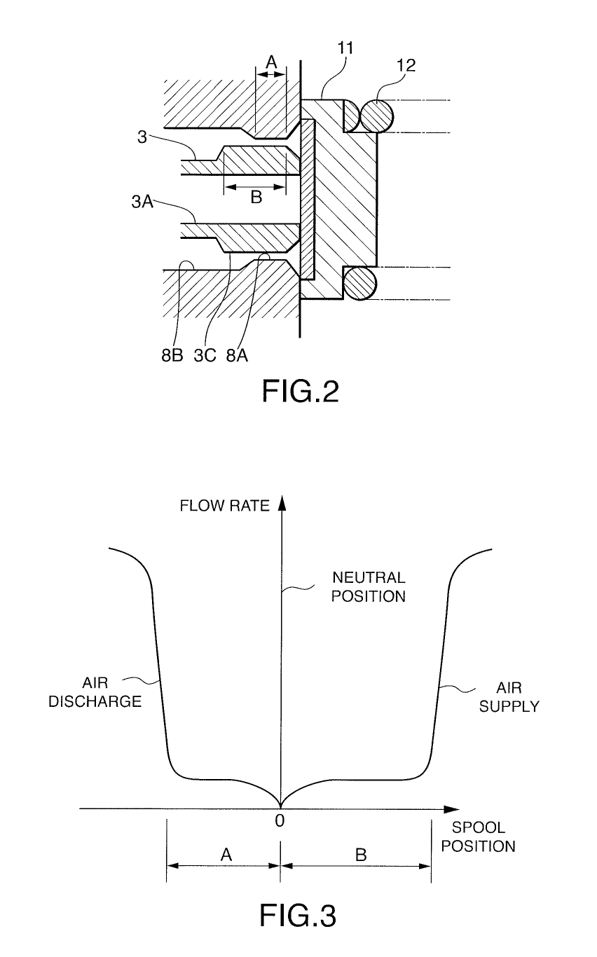

Referring to FIG. 2, an enlarged diameter portion 3C is formed on the end portion of the spool 3 facing the valve body 11. In relation thereto, a contracted portion 8A is formed in the spool hole 8. In a section adjacent to the contracted portion 8A including an opening portion of the air spring passage 4, the spool hole 8 is formed with a considerably larger diameter than the spool 3. This part of the spool hole 8 will be referred to as an enlarged diameter portion 8B.

Referring back to FIG. 1, on the space 9 side of the enlarged diameter portion 8B, the spool hole 8 is formed with a diameter that enables the spool 3 to slide thereon. A ring seal 13 is disposed in the spool hole 8 in this part. Referring back to FIG. 2, a space between the enlarged diameter portion 8B and the spool 3 has a large enough surface area to ensure that no particular resistance is applied to a flow of air. An annular gap formed by the contracted portion 8A and the enlarged diameter portion 3C, on the other hand, is much narrower than the space between the enlarged diameter portion 8B and the spool 3, and therefore obvious resistance is generated relative to the flow of air.

An axial length of the contracted portion 8A is set as A, and an axial length of the enlarged diameter portion 3C is set as B. In the leveling valve 1, the axial length A of the contracted portion 8A and the axial length B of the enlarged diameter portion 3C are set such that a relationship of A#B is satisfied.

Referring back to FIG. 1, in the leveling valve 1, a position in which a center line of the lever 2 and a central axis of the spool 3 form a right angle is set as a neutral position of the spool 3. In the neutral position, the tip end of the spool 3 contacts the valve body 11 in a closed position. It should be noted, however, that in the neutral position, the spool 3 does not exert any lifting force whatsoever on the valve body 11. A relationship between the position of the spool 3 and a rocking angle of the lever 2 is adjusted in advance to obtain this state.

In the leveling valve 1 in the neutral position, the valve body 11 closes the opening portion of the spool hole 8 and the tip end of the spool 3 contacts the valve body 11. Therefore, communication between the space 10 and the air spring passage 4 via the annular gap is blocked. Communication between the hollow portion 3A of the spool 3 and the air spring passage 4 via the annular gap is also blocked. Hence, the air spring passage 4 is substantially closed such that air is neither supplied to nor discharged from the air spring. In this state, the air spring holds the vehicle body in a preset support position. This support position corresponds to the neutral position of the vehicle body.

When a passenger boards or alights from the vehicle, for example, such that a load exerted on the air spring by the vehicle body varies, the air spring expands or contracts in accordance with the increase or reduction in the load, and as a result, the support position in which the air spring supports the vehicle body varies. In response to this load variation, the leveling valve 1 automatically adjusts a pressure of the air spring in order to hold the vehicle body in the neutral position.

When the support position of the vehicle body rises slightly from the neutral position, the spool 3 is driven to a left side of the figure via the lever 2. As a result of this displacement of the spool 3, the tip end of the spool 3 separates from the valve body 11 such that the inside and the outside of the spool 3 communicate via a gap formed between the tip end of the spool 3 and the valve body 11. More specifically, the hollow portion 3A of the spool 3 and the air spring passage 4 communicate with each other via the annular gap between the contracted portion 8A and the enlarged diameter portion 3C. As a result, air in the air spring is discharged into the atmosphere through the air spring passage 4, the annular gap between the contracted portion 8A and the enlarged diameter portion 3C, the gap between the spool 3 and the valve body 11, the hollow portion 3A of the spool 3, and the drain port 3B. At this time, the annular gap between the contracted portion 8A and the enlarged diameter portion 3C applies a flow resistance to the air passing through. Accordingly, the vehicle body descends slowly back to the neutral position.

When the support position of the vehicle body rises greatly, the spool 3 displaces greatly to the left side of the figure. As a result, the enlarged diameter portion 3C of the spool 3 projects to the left side of the figure from the contracted portion 8A such that the annular gap ceases to exist. In this state, the air flowing out of the air spring toward the atmosphere flows out without receiving the flow resistance of the annular gap, and therefore a large amount of air is discharged from the air spring such that the vehicle body descends quickly.

Hence, when the vehicle body is in an elevated position close to the neutral position, the leveling valve 1 discharges air from the air spring little by little in accordance with the resistance of the annular gap such that the support position of the vehicle body is lowered slowly. When the vehicle body is in an elevated position greatly removed from the neutral position, the leveling valve 1 discharges air from the air spring without applying resistance thereto via the annular gap, and therefore the support position of the vehicle body is lowered quickly.

It should be noted that when the support position of the vehicle body nears the neutral position in this case, the spool 3 operating in conjunction with the lever 2 displaces in a direction approaching the valve body 11 such that the enlarged diameter portion 3C invades the contracted portion 8A, and as a result, the annular gap is formed between the enlarged diameter portion 3C and the contracted portion 8A. Thereafter, the support position of the vehicle body is lowered slowly under the flow resistance of the annular gap and finally returned to the neutral position.

At the same time as the support position of the vehicle body returns to the neutral position, the tip end of the spool 3 contacts the valve body 11. Thereafter, the connection between the air spring passage 4 and the drain is blocked such that discharge of the air in the air spring is also blocked. The vehicle body is then held in the neutral position until a new variation occurs in a load condition.

When the support position of the vehicle body is slightly lowered from the neutral position, on the other hand, the lever 2 drives the spool in a rightward direction of the figure. As a result of this displacement of the spool 3, the valve body 11 is lifted from the opening portion of the spool hole 8 such that the space 10 and the air spring passage 4 communicate with each other via the annular gap formed by the enlarged diameter portion 3C and the contracted portion 8A. Since the tip end of the spool 3 contacts the valve body 11, communication between the air spring passage 4 and the drain remains blocked.

In this state, compressed air from the compressor flows into the air spring passage 4 through the annular gap formed by the enlarged diameter portion 3C and the contracted portion 8A, and as a result, the air spring is expanded by the supplied compressed air. At this time, flow resistance is applied to the air passing through the annular gap between the contracted portion 8A and the enlarged diameter portion 3C. Therefore, the vehicle body rises slowly back to the neutral position.

When the support position of the vehicle body is lowered greatly from the neutral position, the spool 3 displaces greatly to the right side of the figure. The enlarged diameter portion 3C of the spool 3 projects to the outside of the spool hole 8 while pushing the valve body 11, and therefore the annular gap ceases to exist. In this state, the compressed air flowing into the air spring from the space 10 flows into the air spring passage 4 through a space between the spool hole 8 and the spool 3 without resistance. As a result, a large amount of compressed air is supplied to the air spring such that the air spring raises the support position of the vehicle body quickly.

Hence, when the vehicle body is in a lowered position close to the neutral position, the leveling valve 1 supplies compressed air to the air spring from the space 10 through the air spring passage 4 little by little in accordance with the resistance of the annular gap such that the vehicle body rises slowly. When the vehicle body is in a lowered position greatly removed from the neutral position, the leveling valve 1 supplies a large amount of compressed air to the air spring without applying resistance thereto via the annular gap, and therefore the support position of the vehicle body is raised quickly.

It should be noted that when the support position of the vehicle body nears the neutral position in this case, the spool 3 operating in conjunction with the lever 2 displaces to the left side of the figure such that the enlarged diameter portion 3C reinvades the contracted portion 8A, and as a result, the annular gap is formed between the enlarged diameter portion 3C and the contracted portion 8A. Thereafter, the support position of the vehicle body is raised slowly under the flow resistance of the annular gap and finally returned to the neutral position.

In the leveling valve 1, as described above, the axial length A of the contracted portion 8A of the spool hole 8 and the axial length B of the enlarged diameter portion 3C of the spool 3 are set at different values.

FIG. 2 shows a case in which the axial length B of the enlarged diameter portion 3C exceeds the axial length A of the contracted portion 8A. When the spool 3 displaces in the leftward direction of the figure in this case, the annular gap disappears at a point where a displacement distance of the spool 3 reaches A. When the spool 3 displaces in the rightward direction of the figure, on the other hand, the annular gap does not disappear until the displacement distance of the spool 3 reaches B.

Hence, as shown in FIG. 3, the leveling valve 1 exhibits different flow rate characteristics when air is supplied to the air spring and when air is discharged from the air spring. More specifically, during air discharge when the spool 3 is operated in the leftward direction of FIG. 2, the flow resistance decreases rapidly, leading to a rapid increase in the flow rate, at the point where the displacement distance of the spool 3 reaches A, whereas during air supply when the spool 3 is operated in the rightward direction of FIG. 2, a similar decrease does not occur until the displacement distance of the spool 3 reaches B. In other words, when the vehicle body raises from the neutral position, a large amount of air is discharged into atmosphere from the air spring at a comparatively early stage such that the operation to lower the vehicle body is executed quickly, whereas when the vehicle body descends from the neutral position, the flow rate of the compressed air supplied to the air spring from the space 10 is kept small until the vehicle body descends greatly. To put it another way, when the vehicle body rises or descends beyond a fixed range, an operation to lower the raised vehicle body is performed more quickly than an operation to raise the lowered vehicle body.

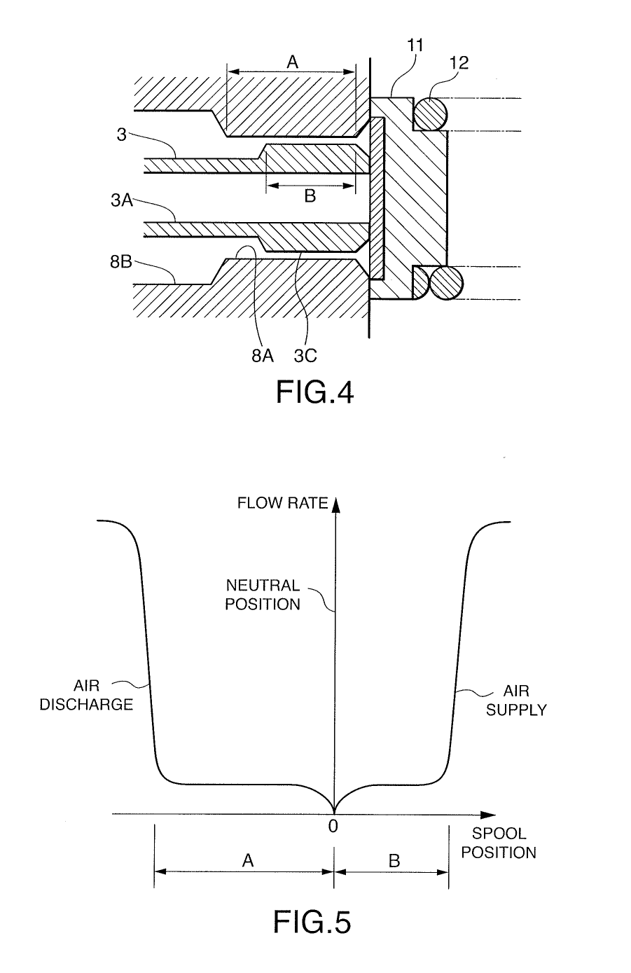

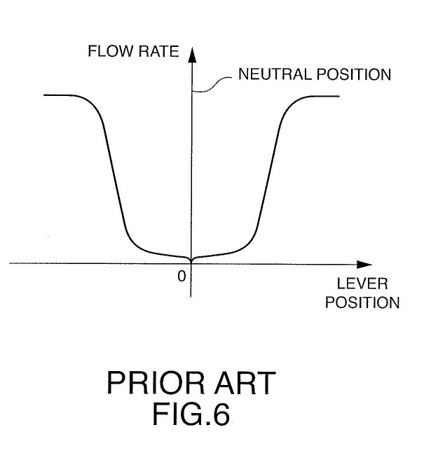

FIG. 4 shows a case in which the axial length A of the contracted portion 8A exceeds the axial length B of the enlarged diameter portion 3C. Likewise in this case, when the spool 3 displaces in the leftward direction of the figure, the annular gap disappears at the point where the displacement distance of the spool 3 reaches A, and when the spool 3 displaces in the rightward direction of the figure, the annular gap disappears at the point where the displacement distance of the spool 3 reaches B. In contrast to the case shown in FIG. 2, however, a relationship of A>B is established, and therefore, as shown in FIG. 5, the leveling valve 1 exhibits different flow rate characteristics when air is supplied to the air spring and when air is discharged from the air spring. More specifically, a large amount of air is supplied to the air spring at a comparatively early stage when the vehicle body descends from the neutral position such that the operation to raise the vehicle body is executed quickly, whereas when the vehicle body raises from the neutral position, the flow rate of the air discharged into atmosphere from the air is kept small until the vehicle body raises greatly. In other words, when the vehicle body rises or descends beyond a fixed range, the operation to raise the lowered vehicle body is performed more quickly than the operation to lower the raised vehicle body.

Hence, in the leveling valve 1, a range of a small flow region generated by the annular gap differs on the air supply side and the air discharge side both when A>B and when B>A. In the leveling valve 1, the difference between the flow rate characteristics can be realized as desired by setting the values of A and B, and therefore actual air spring characteristics can be matched optimally in accordance with a required resilience of the air spring that supports the vehicle body. It should be noted that selection of the A>B setting or the B>A setting may be performed taking into consideration a support condition in which the air spring is to support the vehicle body.

Further, by employing the leveling valve 1, an increase in setting freedom can be obtained with respect to the setting of air spring characteristics for realizing favorable stability and passenger comfort in the vehicle.

Furthermore, as shown in FIGS. 3 and 5, the leveling valve 1 exhibits asymmetrical flow rate characteristics, and therefore the leveling valve 1 is provided with a favorable characteristic whereby hunting is unlikely to occur in the vicinity of the neutral position while a high degree of responsiveness is maintained.

The contents of Tokugan 2009-145354, with a filing date of Jun. 18, 2009 in Japan, are hereby incorporated by reference.

Although the invention has been described above with reference to certain embodiments, the invention is not limited to the embodiments described above. Modifications and variations of the embodiments described above will occur to those skilled in the art, within the scope of the claims.

For example, in the above embodiments, the first passage 5 is connected to the compressor serving as the air pressure source and the second passage 6 is connected to the drain. However, the first passage may be connected to the drain and the second passage may be connected to the compressor serving as the air pressure source.

### INDUSTRIAL APPLICABILITY

A leveling valve according to this invention is suitable for automatically adjusting a support position of a vehicle body of a railway vehicle using an air spring.

The embodiments of this invention in which an exclusive property or privilege is claimed are defined as follows:

1. A leveling valve that selectively connects an air pressure source and a drain to an air spring, comprising:
a spool hole having a contracted portion in an opening portion thereof;
a spool that displaces in an axial direction within the spool hole in accordance with a load exerted on the air spring, the spool having an enlarged diameter portion formed on an outer periphery thereof so as to face the contracted portion and a hollow portion, and the enlarged diameter portion formed with a larger outer diameter than another part of the spool, wherein an annular gap is formed between the enlarged diameter portion and the contracted portion and an axial length of the enlarged diameter portion differs from an axial length of the contracted portion;
an air spring passage that communicates with the air spring and faces an outer periphery of the spool;
a valve body seated on the opening portion of the spool hole so as to face the spool;
a spring that elastically supports the valve body in a seated position;
a first passage that connects one of the air pressure source and the drain to the air spring passage via the annular gap when the valve body is pushed by the spool so as to be lifted from the opening portion of the spool hole: and
a second passage that connects another of the air pressure source and the drain to the air spring passage via the annular gap and the hollow portion when the spool displaces in a retreating direction from the valve body.

2. The leveling valve as defined in claim 1, wherein the axial length of the enlarged diameter portion is set to be longer than the axial length of the contracted portion.

3. The leveling valve as defined in claim 1, wherein the axial length of the contracted portion is set to be longer than the axial length of the enlarged diameter portion.

4. The leveling valve as defined in claim 1, wherein the air spring passage communicates with the annular gap at all times, the first passage is connected to the air pressure source, and the second passage is connected to the drain, communication between the first passage and the annular gap is blocked when the valve body is seated on the opening portion of the spool hole, whereas the first passage communicates with the annular gap when the valve body is lifted from the opening portion of the spool hole, and communication between the hollow portion and the annular gap is blocked when the spool contacts the valve body, whereas the hollow portion communicates with the annular gap when the spool displaces in the retreating direction from the valve body.

5. The leveling valve as defined in claim 1, wherein the spool is configured to lift the valve body from the opening portion of the spool hole in accordance with an increase in the load exerted on the air spring and displace in the axial direction within the spool hole in the retreating direction from the valve body in accordance with a reduction in the load exerted on the air spring.
